(19) United States
(12) Patent Application Publication
(10) Pub. No.: US 2009/0273117 A1
(43) Pub. Date: Nov. 5, 2009

(54) Guiding apparatus

(76) Inventors: Joseph T. Sowder, Pelham, AL (US); Karen C. Sowder, Pelham, AL (US)

Correspondence Address: JAMES RAY & ASSOCIATES, 2640 Pitcairn Road, Monroeville, PA, 15146, US

(21) Appl. No.: 12/150,691

(22) Filed: Apr. 30, 2008

(51) Int. Cl. C08F 112/08; B32B 27/32; B32B 3/00; B32B 3/06; B28B 11/00

(52) U.S. Cl. 264/232; 526/347.2; 428/220; 428/156; 428/99

(57) ABSTRACT

A guiding apparatus for aiding a user in at least one of pouring, spreading, applying, shaping, troweling and sloping a predetermined amount of at least one of concrete and cement is provided. Such guiding apparatus includes at least one guide member manufactured from a predetermined material and having a predetermined size and a predetermined shape.

### FIELD OF THE INVENTION

The present invention relates, in general, to concrete and cement and, more particularly, this invention relates to devices to aid in the pouring, spreading, applying, shaping, troweling and sloping of concrete and cement.

### BACKGROUND OF THE INVENTION

Prior to the conception and development of the present invention, concrete and cement, as are generally well known in the prior art, are used for various reasons including creating sidewalks, driveways, flooring, shower bases, support structures and in basements. Concrete and cement, however, can be difficult to apply evenly, especially to areas that are sloped, awkward, angled, curved, or irregular. Therefore, there exists a need for an apparatus which will aid a person in pouring, spreading, applying, shaping, troweling, and sloping concrete and cement.

### SUMMARY OF THE INVENTION

The present invention provides a guiding apparatus for aiding a user in at least one of pouring, spreading, applying, shaping, troweling and sloping a predetermined amount of at least one of concrete and cement. Such guiding apparatus includes at least one guide member manufactured from a predetermined material and having a predetermined size and a predetermined shape.

According to another embodiment, a method of at least one of pouring, spreading, applying, shaping, troweling and sloping a predetermined amount of at least one of concrete and cement is provided. Such method includes the steps of providing at least one guide member manufactured from a predetermined material and having a predetermined size and a predetermined shape. Placing such at least one guide member in a predetermined position at least one of within and around a predetermined area in which such predetermined amount of such at least one of concrete and cement is to be placed. Pouring such predetermined amount of such at least one of concrete and cement within such predetermined area. At least one of spreading, applying, shaping, troweling and sloping such predetermined amount of such at least one of concrete and cement such that such predetermined amount of such at least one of concrete and cement is aligned with such at least one guide member. Waiting a predetermined amount of time such that such predetermined amount of such at least one of concrete and cement has set to a predetermined degree. Removing such at least one guide member. Pouring a predetermined additional amount of at least one of concrete and cement as necessary such that any unwanted spaces left by the removal of such at least one guide member are filled as desired.

### OBJECTS OF THE INVENTION

It is, therefore, one of the primary objects of the present invention to provide an apparatus which can be used to aid a person in pouring, spreading, applying, shaping, and sloping concrete and cement.

Another object of the present invention is to provide a device which can be cut or broken to fit a particular sized area such that the device provides a guide for pouring, spreading, applying, shaping, and sloping concrete and cement.

Still another object of the present invention is to provide a device which can be used to provide a downward sloping support guide for a person who is sloping concrete in a downward direction.

Yet another object of the present invention is to provide a simple to use non-absorbent fluid impervious device for use in pouring, spreading, applying, shaping, troweling and sloping concrete and cement.

An additional object of the present invention is to provide an apparatus for pouring, spreading, applying, shaping, and sloping concrete and cement which can be removed before the concrete and cement is fully set and which will not affect the setting of such concrete and cement.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention in which such guide member has a height that is tapered along a length of such guide member.

FIG. 3 is a partial perspective view of the invention according to one embodiment of the invention in which an adhesive type securing means is disposed on a predetermined portion of such guide member.

FIG. 4 is a partial perspective view of the invention according to one embodiment of the invention; in this view a plurality of such guide members are disposed around a drain such that a user will be aided by such guide members while at least one of pouring, spreading, applying, shaping, troweling and sloping a predetermined amount of at least one of concrete and cement around such drain.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

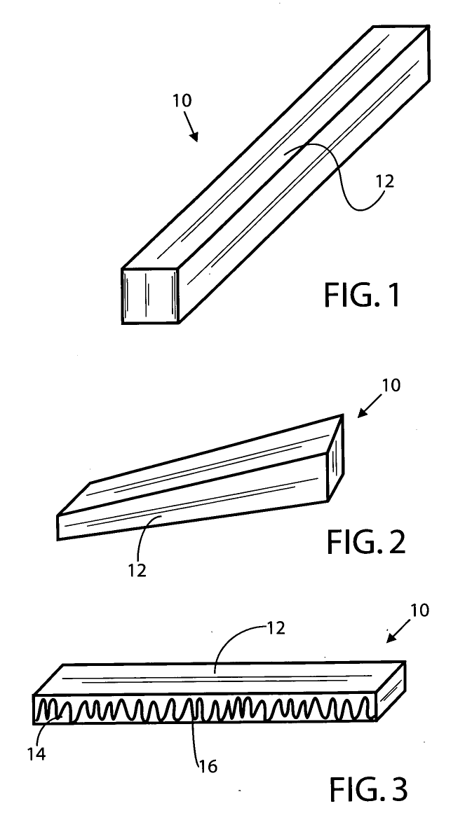

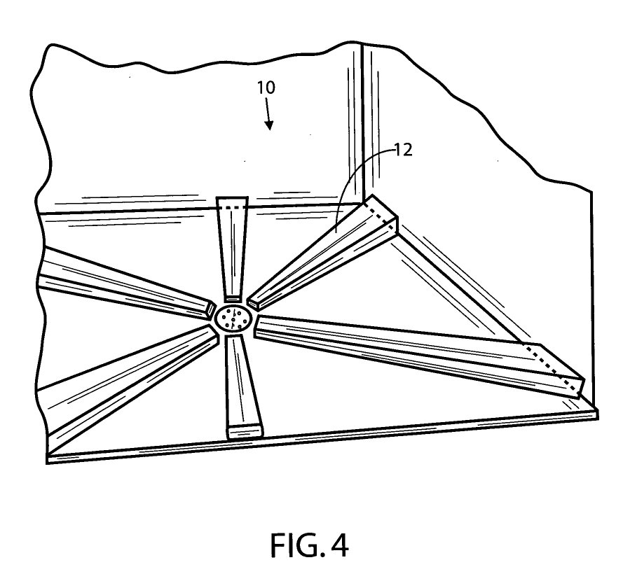

Reference is now made, more particularly, to FIGS. 1-4.

A guiding apparatus, generally designated 10, for aiding a user (not shown) in at least one of pouring, spreading, applying, shaping, troweling and sloping a predetermined amount of at least one of concrete and cement is provided. Such guiding apparatus 10 includes at least one guide member 12 manufactured from a predetermined material and having a predetermined size and a predetermined shape.

It is presently preferred that such predetermined material is at least one of non-absorbent, water resistant, fluid impervious, and a combination thereof. It is further presently preferred that such predetermined material is at least one of polystyrene, plastic, and a foam type material. It is presently most preferred that such predetermined material is polystyrene.

It is presently preferred that such at least one guide member 12 is between about 36.0 inches and about 108.0 inches long. It is presently preferred that such least one guide member 12 is between about 0.5 and about 1.0 inches wide. It is presently preferred that such at least one guide member 12 is between about 0.25 inches and about 3.0 inches high.

It is presently preferred that such at least one guide member 12 has a height that is tapered along a length of such at least one guide member 12 at a predetermined rate. It is presently preferred that such predetermined rate is between about 0.125 inches and about 0.50 inches per foot.

It is presently preferred that such guide member 12 is at least one of breakable and cuttable such that a user can at least one of break and cut such guide member 12 to at least one of a predetermined size and shape.

It is presently preferred that such guide member 12 includes a securing means 14 disposed on a predetermined portion of such guide member 12 for releasably securing such guide member 12 to at least one of a floor, a wall, and a support member. It is further presently preferred that such securing means 14 is an adhesive type securing means 16.

According to another embodiment, a method of at least one of pouring, spreading, applying, shaping, troweling and sloping a predetermined amount of at least one of concrete and cement is provided.

Such method includes the steps of providing at least one guide member manufactured from a predetermined material and having a predetermined size and a predetermined shape. Placing such at least one guide member in a predetermined position at least one of within and around a predetermined area in which such predetermined amount of such at least one of concrete and cement is to be placed. Pouring such predetermined amount of such at least one of concrete and cement within such predetermined area. At least one of spreading, applying, shaping, troweling and sloping such predetermined amount of such at least one of concrete and cement such that such predetermined amount of such at least one of concrete and cement is aligned with such at least one guide member. Waiting a predetermined amount of time such that such predetermined amount of such at least one of concrete and cement has set to a predetermined degree. Removing such at least one guide member. Pouring a predetermined additional amount of at least one of concrete and cement as necessary such that any unwanted spaces left by the removal of such at least one guide member are filled as desired.

It is presently preferred that such method further includes the step of at least one of cutting and breaking such guide member such that such guide member is at least one of a predetermined size and shape prior to placing such at least one guide member in such predetermined position.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A guiding apparatus for aiding a user in at least one of pouring, spreading, applying, shaping, troweling and sloping a predetermined amount of at least one of concrete and cement comprising at least one guide member manufactured from a predetermined material and having a predetermined size and a predetermined shape.

2. A guiding apparatus according to claim 1 wherein said predetermined material is at least one of non-absorbent, water resistant, fluid impervious, and a combination thereof.

3. A guiding apparatus according to claim 1 wherein said predetermined material is at least one of polystyrene, plastic, and foam type material.

4. A guiding apparatus according to claim 3 wherein said predetermined material is polystyrene.

5. A guiding apparatus according to claim 1 wherein said at least one guide member is between about 36.0 inches and about 108.0 inches long.

6. A guiding apparatus according to claim 1 wherein said at least one guide member is between about 0.5 and about 1.0 inches wide.

7. A guiding apparatus according to claim 1 wherein said at least one guide member is between about 0.25 inches and about 3.0 inches high.

8. A guiding apparatus according to claim 1 wherein said at least one guide member has a height that is tapered along a length of said at least one guide member at a predetermined rate.

9. A guiding apparatus according to claim 8 wherein said predetermined rate is between about 0.125 inches and about 0.50 inches per foot.

10. A guiding apparatus according to claim 1 wherein said guide member is at least one of breakable and cuttable such that a user can at least one of break and cut said guide member to at least one of a predetermined size and shape.

11. A guiding apparatus according to claim 1 wherein said guide member includes a securing means disposed on a predetermined portion of said guide member for releasably securing said guide member to at least one of a floor, a wall, and a support member.

12. A guiding apparatus according to claim 11 wherein said securing means is an adhesive type securing means.

13. A method of at least one of pouring, spreading, applying, shaping, troweling and sloping a predetermined amount of at least one of concrete and cement comprising the steps of:
a. providing at least one guide member manufactured from a predetermined material and having a predetermined size and a predetermined shape;
b. placing said at least one guide member in a predetermined position at least one of within and around a predetermined area in which said predetermined amount of said at least one of concrete and cement is to be placed;
c. pouring said predetermined amount of said at least one of concrete and cement within such predetermined area;
d. at least one of spreading, applying, shaping, troweling and sloping said predetermined amount of said at least one of concrete and cement such that said predetermined amount of said at least one of concrete and cement is aligned with said at least one guide member;
e. waiting a predetermined amount of time such that said predetermined amount of said at least one of concrete and cement has set to a predetermined degree;
d. removing said at least one guide member; and
e. pouring a predetermined additional amount of at least one of concrete and cement as necessary such that any unwanted spaces left by the removal of said at least one guide member are filled as desired.

14. A method according to claim 11 wherein said method further includes the step of at least one of cutting and breaking said guide member such that said guide member is at least one of a predetermined size and shape prior to placing said at least one guide member in said predetermined position.
